(19) United States
(12) Patent Application Publication
(10) Pub. No.: US 2008/0192945 A1
(43) Pub. Date: Aug. 14, 2008

(54) Audio system and method

(76) Inventor: William Mcconnell, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/703,879

(22) Filed: Feb. 8, 2007

(51) Int. Cl. H04B 3/20

(52) U.S. Cl. 381/66

(57) ABSTRACT

A method of providing an audio signal to an audio output device may include receiving a first audio signal generated by a microphone located in a physical environment; processing the first audio signal at least to provide echo cancellation to obtain an echo-canceled first audio signal; generating a livening signal based on the echo-canceled first audio signal; and providing the generated livening signal to an audio output device located in the physical environment.

### FIELD OF THE INVENTION

The present invention relates to audio signals.

### BACKGROUND OF THE INVENTION

In remote teleconferencing, one or more individual participants are located in a first environment (e.g. room), and one or more individual participants are located in at least one other remote room. Microphones in each room convert sound from the room into audio signals, which are provided to loudspeakers in the other room.

It is often desirable for the audio output in each room to appear to the listener to be as close as possible to the audio output that would be experienced were all of the participants in the same room. If participants are all in the same room, participants hear (1) sound transmitted directly from the speaking individual, sometimes called the direct effect, (2) some echoes from sounds being reflected one or a few times, generally called early reflections, and (3) some later and much lower amplitude echoes, generally called reverberations. Individuals generally expect, at least subconsciously, to hear early reflections and reverberations, and for such early reflections and reverberations from the voices of all participants to be of similar amplitude. The early reflections and reverberations contribute to the listener's impression of the room.

Microphones in rooms used for teleconferencing tend to output audio signals which include direct sound, early reflections and reverberations from the loudspeakers, as well as the participants. The signals from the loudspeakers create undesirable echo in the remote room, so audio signals are generally processed through acoustic echo cancellation (AEC) systems and devices in an effort to cancel the returning feedback. AEC systems have difficulty in removing all of this feedback.

Microphones output signals including direct audio, early reflections and reverb from the remote room. Then these signals are output from a local loudspeaker; early reflections and reverb occur in the local room before being heard by the local listener. Thus remote vocals feature additional reflections and reverb compared to local vocals, so that remote vocals sound different from local vocals. In other words, to a listener in a local room, vocals from a participant in the local room sound acoustically different from vocals from a participant in a remote room because the local vocals have just the local acoustics, but the remote vocals include the local acoustics plus the remote acoustics.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts and:

FIG. 1 shows a schematic diagram of a system according to an embodiment;

FIG. 2A shows a chart of a magnitude-only impulse response of an exemplary livening system;

FIG. 2B shows a chart of a magnitude-only impulse response of an alternative exemplary livening system;

FIG. 3 is a process flow diagram of a process according to an embodiment;

FIG. 4 is a process flow diagram of a process according to an alternative embodiment.

### DETAILED DESCRIPTION OF THE PREFERRED EMBODIMENTS

The following description of the preferred embodiments is merely by way of example and is in no way intended to limit the invention, its application, or uses.

In teleconferencing, it is desirable that the voices of both the participants in one's own room, and the participants in other rooms, sound similar to the sound perceived as if all participants were in the same room. The perception of an individual being in the same room is dependent to some extent on the perception of echoes from the individual's voice. In a room, an individual's voice typically is reflected, with attenuation, from walls and furniture within the room. The voice may be reflected more than one time, with attenuation with each reflection. The voice may be reflected with differing frequency characteristics each time as well. For example, the frequency characteristics of a reflection from upholstered furniture are different from the frequency characteristics of a reflection from wooden furniture or from drywall.

The acoustic echo cancellation devices are more effective in a room with fewer echoes. In teleconferencing from a room that has audio characteristics that resemble an anechoic chamber, with minimal sound reflections from the walls, relatively few echoes will be transmitted. Accordingly, comprehension between participants in different locations is generally very good if both locations are rooms that have audio characteristics that resemble an anechoic chamber. In addition, the voices of participants in all locations sound similar. However, participants find that conducting conversations in a room having audio characteristics that resemble an anechoic chamber to be uncomfortable. While comprehension is good, the absence of echoes provides an experience which does not resemble a conversation in a typical room. If the room characteristics are changed so that sound echoes to a somewhat greater extent, the experience of a listener is more natural, but comprehension of conversations deteriorates if there is substantial echo content beyond about 50 milliseconds.

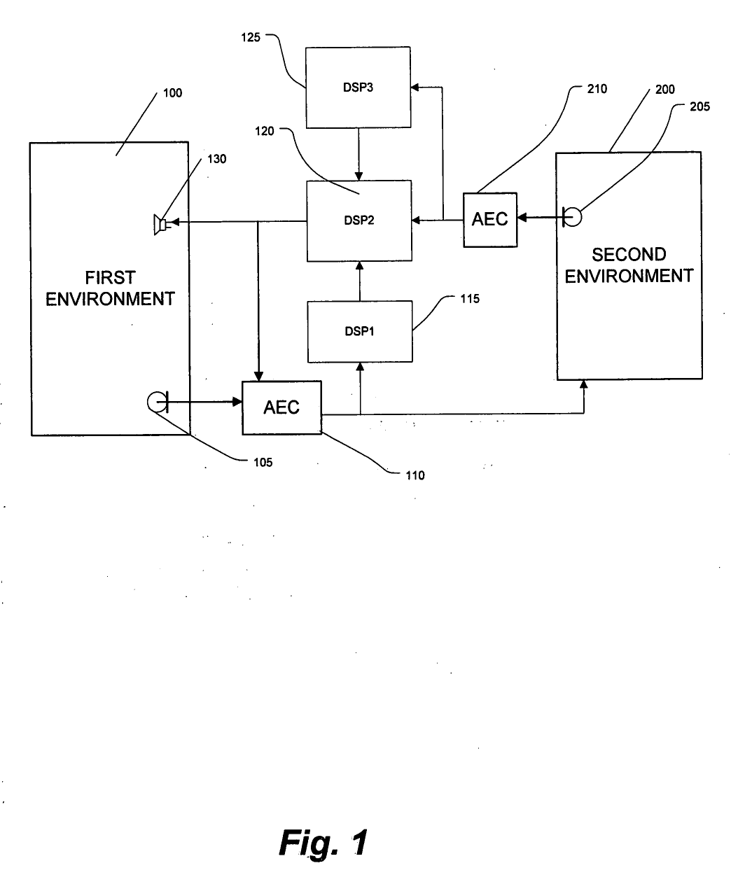

Referring to FIG. 1, there is shown a schematic representation showing first physical environment 100 and second physical environment 200. First and second physical environments 100 and 200 may be environments suitable for use by humans, and may be chambers suitable for occupation by humans. First and second physical environments 100, 200 may be rooms having a floor, ceiling, generally surrounding walls with one or more doors therein. The walls may be, by way of example, of wallboard or other construction, or may have coverings and/or be made of materials that reduce or eliminate echoes. By way of example, first environment 100 may be a local room, and second environment 200 may be a remote room. Either or both of first and second physical environments may have audio characteristics that resemble an anechoic chamber. The rooms may be of dimensions typical of office or residential use. The physical environments may contain one or more items of furniture, such as tables, desks and chairs.

At least one microphone 105 may be located in first physical environment 100, so positioned as to provide an output signal indicative of sounds in first physical environment 100. Microphone 105 generates an audio signal, which is received by first acoustic echo cancellation device (AEC 1) 110. Acoustic echo cancellation device 110 processes the received audio signal, using the output of DSP2 120 as a cancellation signal reference, and outputs an echo-canceled first audio signal. The echo-canceled first audio signal may completely cancel echoes, or substantially reduce the amplitude of echoes as compared to the audio signal output by microphone 105.

The echo-canceled first audio signal is output to second physical environment 200. The echo-canceled first audio signal may be input to one or more signal processing devices, or directly to loudspeakers or other audio output devices in second physical environment 200. The echo-canceled first audio signal may also be input to a first digital signal processor 115. First DSP 115 generates a livening signal based on the echo-canceled first audio signal. A livening signal is a signal that, when used to generate audio (such as by input to a loudspeaker), causes a listener to have the impression that there are one or more echoes of the underlying signal, thus giving the sense that the room acoustics are different than without the livening signal. By way of example, a livening signal may include one or more attenuated repetitions of an original signal. The attenuated repetitions may have the same frequency and phase characteristics as the original signal, or may have different frequency and phase characteristics. By way of example, a certain range of frequencies may be more attenuated than other frequency ranges. The first attenuated repetition may follow the original signal by a delay, for example a period of between about 5 milliseconds and about 30 milliseconds, and may follow by a delay of about 10 milliseconds. Each subsequent repetition may follow by the same or a different period. Each repetition may have lower amplitude than the original signal, and lower or higher amplitude than a preceding repetition. The repetitions may include a series of repetitions with the same or with varying delays. The repetitions may include more than one series of repetitions, which may include different delays, attenuations, frequency and phase characteristics.

By way of example, commercially available effects may be employed, such various early reflections effects available in software and digital signal processors. Commercially available early reflections effects may emulate various environments, such as various types of indoor locations and outdoor locations. The livening signal may also include reverberation effects. Such reverberation effects are commercially available.

First DSP 115 outputs a livening signal based on the echo-canceled audio signal received from AEC 110. The output livening signal has one or more copies of the echo-canceled audio signal, which copies are delayed, and may be phase changed, and attenuated, including attenuation and phase change varying by frequency. The output livening signal is provided to a second digital signal processor 120 which performs a function of adding or combining more than one input signal. Second digital signal processor 120 also receives a signal from second environment 200. The signal received from second environment 200 may be an acoustic echo canceled signal. The acoustic echo canceled signal from second environment 200 may be a signal received from microphone 205 located in second environment 200 and acoustic echo canceled by second acoustic echo cancellation device (AEC 2) 210. The acoustic echo canceled signal from second environment 200 may also be provided to third digital signal processor 125. Third digital signal processor 125 generates a livening signal based on the acoustic echo canceled signal. Third digital signal processor 125 may provide a second livening signal based on the second audio signal. The relationship of a livening signal and an original audio signal are explained above. The second livening signal is provided to second digital signal processor 120.

Second digital signal processor 120 operates as a summer, and outputs an audio signal which is the sum of the acoustic echo canceled signal from the second environment, the livening signal based on the acoustic echo canceled signal from microphone 105 located in the first environment 100, and the livening signal based on the acoustic echo canceled signal from the second environment. The audio signal from second DSP 120 is output to an audio output device 130 located in the first environment 100. Audio output device 130 may be, by way of example, a loudspeaker.

The signals described above may be processed and provided to audio output devices in real time.

For example, if first environment 100 has audio characteristics similar to those of an anechoic chamber, the output of the livening signal based on the output of AEC 110 may be set up to provide a more natural quality to the voices of participants in first environment 100. The addition of the livening signal based on the output from second environment 200 may be set up to create a more natural quality to voices of participants in second environment 200 when the participants in environment 100 hear them.

If first environment 100 has audio characteristics which are different from those of an anechoic chamber, but are not desirable, the livening signals may be selected to compensate for the audio characteristics of the first environment. For example, if the first environment reflects lower frequency sound preferentially as compared to higher frequency sound, and it is desired to have both higher and lower frequency sounds the livening signal may be adjusted to appropriately repeat higher frequency sounds.

The audio signal output by second DSP 120 is also provided to AEC 110, providing a signal cancellation reference. The AEC 110 employs this reference input audio signal to help cancel the direct audio and echoes resultant from audio output device 130 and received by microphone 105.

If environments 100 and 200 have similar audio qualities, as a result of similar construction and furnishings, for example, but there is no system associated with second environment 200 adapted to provide a livening signal to a loudspeaker in second environment 200, then vocals in second environment 200 will sound less lively than those in first environment 100.

The functions of AEC 110 and digital signal processors 115, 120, 125 may be performed by separate devices, or by one, two or three devices, such as a suitably programmed digital signal processor, or by software causing a processor to execute steps so as to implement the respective functions.

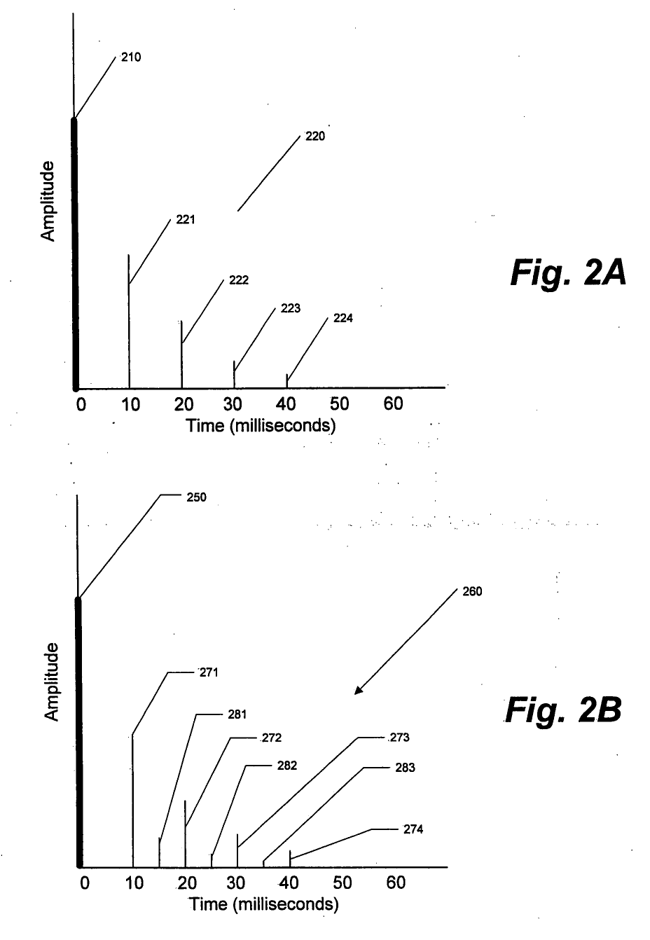

Referring now to FIG. 2A, there is shown a chart of a magnitude-only impulse response of an exemplary livening system. Components of this graph are an original echo-canceled signal in the form of a dry (i.e. without echoes) audio impulse 210, and livening signal 220 based on audio impulse 210, including a series of attenuated repetitions at 221, 222, 223 and 224. The series occur at intervals of 10 milliseconds. There are no repetitions at 50 milliseconds or greater in this exemplary chart. However, in other embodiments, delays of 50 milliseconds or greater may be desirable.

Referring now to FIG. 2B, there is shown a chart of a magnitude-only impulse response of an alternative exemplary livening system. Components of this graph include an original echo-canceled signal in the form of a dry audio impulse 250, and livening signal 260 based on audio impulse 250, including a first series of repetitions 271, 272, 273, 274 and a second series of repetitions 281, 282, 283. First series includes a series of gradually decreasing repetitions, separated by intervals of about 10 milliseconds, and ending at about 40 milliseconds after the initial pulse. Second series includes a series of gradually decreasing repetitions of lower amplitude than those of first series 270, separated from one another by about 10 milliseconds and separated from repetitions of the first series by about 5 milliseconds. The frequency and phase characteristics of the first series and the second series may be the same, or may be different.

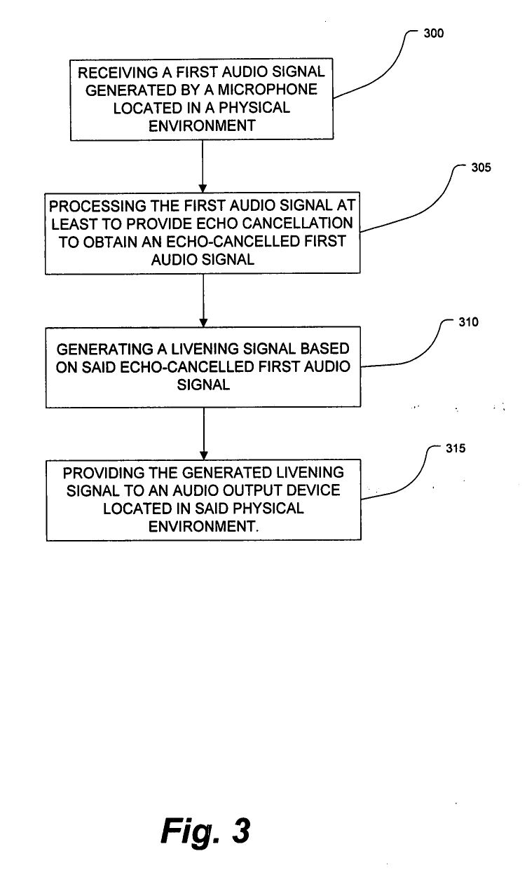

Referring now to FIG. 3, a process flow of a method according to an embodiment will be described. As indicated by block 300, a first audio signal generated by a microphone located in a physical environment is received. The first audio signal may be generated by microphone 105 of FIG. 1 and received by AEC 110 of FIG. 1. As indicated by block 305, the first audio signal may be processed at least to provide echo cancellation to obtain an echo-canceled first signal. A livening signal is generated based on the echo-canceled first signal, as indicated by block 310. The generated livening signal is provided to an audio output device located in the physical environment, as indicated by block 315.

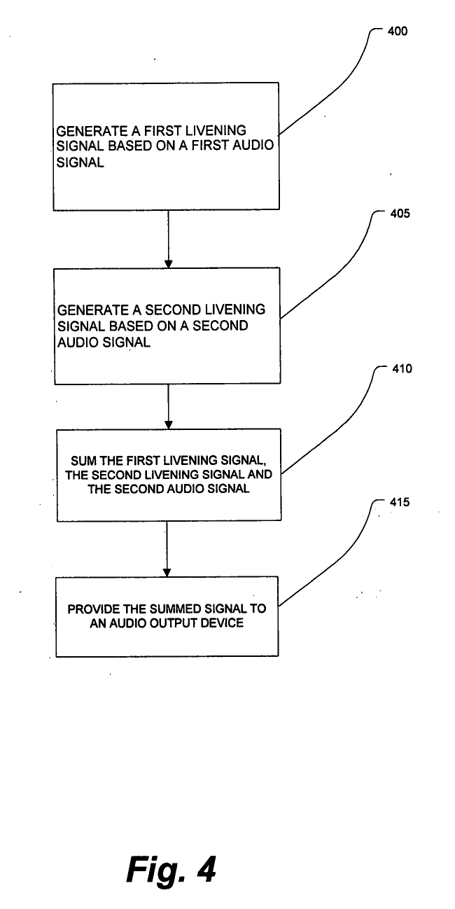

Referring now to FIG. 4, a process flow of a method according to another embodiment will be described. A first livening signal is generated based on a first audio signal, as indicated by block 400. The first audio signal may be an echo-canceled signal received from microphone 105 of FIG. 1, for example. A second livening signal is generated based on second audio signal, as indicated by block 405. The first livening signal, the second livening signal and the second audio signal are summed to obtain an output signal, as indicated by block 410. The output signal is provided to an audio output device, such as a loudspeaker, as indicated by block 415.

Advantages of embodiments include avoiding undesired feedback and an ability to adjust the perception of the participants of the audio characteristics of each physical environment. By way of example, a room with characteristics similar to those of an anechoic chamber may be employed, while the participants have the impression of being in a room having different audio characteristics. By way of further example, an embodiment may be implemented in a teleconference between or among rooms having different audio or acoustic characteristics to cause the participants to have the impression that the rooms all have the same audio or acoustic characteristics.

It will be appreciated that the embodiments described and illustrated herein are merely exemplary.

What is claimed is:

1. A method of providing an audio signal to an audio output device, comprising:
receiving a first audio signal generated by a microphone located in a physical environment;
processing said first audio signal at least to provide echo cancellation to obtain an echo-canceled first audio signal;
generating a livening signal based on said echo-canceled first audio signal;
providing the generated livening signal to an audio output device located in said physical environment.

2. The method of claim 1, wherein said physical environment is a room.

3. The method of claim 1, wherein said livening signal comprises said echo-canceled first audio signal with a delay and a reduction in amplitude.

4. The method of claim 3, wherein said livening signal comprises a plurality of repetitions of said echo-canceled first audio signal, each with a reduction in amplitude relative to said first audio signal.

5. The method of claim 4, wherein frequency components of said repetitions differ from frequency components of said echo-canceled first audio signal.

6. The method of claim 4, wherein said repetitions comprise a first series of repetitions, each repetition in said first series having a reduction in amplitude relative to the immediately preceding repetition in the series, and a second series of repetitions, each repetition in the second series following and having a lower amplitude than a repetition in the first series.

7. The method of claim 3, wherein said repetitions comprise a first series of repetitions, each repetition in said first series having a reduction in amplitude relative to the immediately preceding repetition in the series, and wherein the first repetition follows the first audio signal by an interval of between about 10 milliseconds and about 20 milliseconds, and wherein each repetition in the series after the first repetition follows the immediately preceding repetition by an interval of between about 10 milliseconds and about 20 milliseconds.

8. A method of providing an audio signal to an audio output device, comprising:
generating a first livening signal based on a first audio signal;
generating a second livening signal based on a second audio signal;
summing the first livening signal, the second livening signal, and the second audio signal to obtain a livened second audio signal; and
providing the livened second audio signal to the audio output device.

9. The method of claim 8, wherein the first audio signal is an echo-canceled signal received from a microphone located in a first environment.

10. The method of claim 9, wherein the second audio signal is an echo-canceled signal received from a microphone located in a second environment.

11. The method of claim 10, wherein the audio output device comprises a loudspeaker located in the second environment.

12. The method of claim 11, wherein said first livening signal comprises a plurality of repetitions based upon said first audio signal, each of said repetitions based upon said first audio signal having a lower amplitude than said first audio signal, and said second livening signal comprises a plurality of repetitions based upon said second audio signal, each of said repetitions based upon said second audio signal having a lower amplitude than said second audio signal.

13. The method of claim 11, wherein said first environment comprises a first room, and second environment comprises a second room.

14. A system for providing an audio signal to an audio output device, comprising:
an acoustic echo cancellation device having an input coupled to a microphone in a chamber suitable for occupation by humans, the acoustic echo cancellation device operative to output an echo-canceled signal in response to an input signal from the microphone; and
a digital signal processor coupled to an output of said acoustic echo cancellation device operative to generate a livening signal based on said echo canceled signal, an output of said digital signal processor being coupled to an audio output device in the chamber suitable for occupation by humans.

15. The system of claim 14, wherein said digital signal processor is operative to generate a livening signal comprising at least a first series of repetitions of said echo canceled signal, a first of said first series of repetitions having an amplitude less than an amplitude of said echo canceled signal.

16. The system of claim 14, further comprising a second digital signal processor having an input coupled to a microphone in a second chamber suitable for occupation by humans, said second digital signal processor being configured to output to said audio output device an audio signal received from the microphone in the second chamber and a livening signal based on said signal from the second chamber.

17. The system of claim 16, further comprising a summer for summing said livening signal based on said echo canceled signal from said first chamber, said livening signal based on said signal from said second chamber, and said signal from said second chamber, and having an output coupled to said audio output device.

18. The system of claim 17, wherein said output of said summer is coupled to said acoustic echo cancellation device.
